(19) United States
(12) Patent Application Publication
(10) Pub. No.: US 2016/0007408 A1
(43) Pub. Date: Jan. 7, 2016

(54) SELF-ADAPTING SIGNAL COMMUNICATING SYSTEM

(71) Applicant: Toshiba America Electronic Components, Inc., San Jose, CA (US)

(72) Inventor: Rakesh SETHI, San Jose, CA (US)

(21) Appl. No.: 14/322,560

(22) Filed: Jul. 2, 2014

(51) Int. Cl. H04W 84/12; H04B 1/16; H04B 1/3827; H04B 1/04

(52) U.S. Cl. CPC H04W 84/12; H04B 1/04; H04B 1/16; H04B 1/3827

(57) ABSTRACT

A wireless signal communication system controls wireless signal transmission levels in response to detection of attenuation characteristics of a medium in a line of sight of the wireless signals. In one form, the system performs real time detection of moveable objects in a line of sight of sub-terahertz electromagnetic waves delivered to data streaming, charging, and other systems. The system downscales the signal transmission level responsive to the presence of the moveable object in the line of sight or based on an increase attenuation of the signal, and up-scales the signal transmission level responsive to the absence of the moveable object in the line of sight or based on a decrease in the attenuation of the signal.

### TECHNICAL FIELD

The subject application is directed generally to wireless signal communication systems and, more specifically, to control of wireless signal transmission levels in response to detection of attenuation parameters of the wireless signals caused by a medium carrying the wireless signals.

The application is particularly related to real time detection of moveable objects in a line of sight of sub-terahertz electromagnetic waves delivered to data streaming, charging, and other systems, and downscaling and/or up-scaling the signal levels responsive to the presence and/or absence respectively of the moveable object in the line of sight. However, the embodiments are not limited to moveable objects or to line of sight, but include control of signal transmission levels responsive to changes in signal attenuation caused by any reason such as, for example, weather conditions or the like.

### BACKGROUND

Sub-terahertz systems have been used to transmit charging signals to portable device docking stations and the like for delivering power to the docking stations for purposes of recharging batteries within the portable devices, and to simply power other devices configured to receive and utilize the charging signals directly. Other sub-terahertz systems have been used to transmit signals containing information such as for example, video, audio, or other data for delivery to data streaming system receivers.

One advantage of these wireless sub-terahertz signal transmission systems is their energy transmission efficiency wherein highly focused signals are used at high frequencies to deliver energy transmission, the energy and/or data content to the target devices onto which the signals are directed. Relative to omni-directional radiating systems, the sub-terahertz systems generating beam-forming signals are able to focus a substantial entirety of the signal energy on a path toward the target device, rather than simply blanket the adjacent area with undirected radiating electromagnetic waves.

However, these systems are somewhat sensitive to changes in the characteristics of the medium in the line of sight between the beam signal transmitter and the data and or the energy consuming target device. For example, objects passing through the line of sight having a high density relative to air such as animals or people can significantly degrade the signal ultimately delivered having a high density relative to air to the signal consuming device. Essentially, the energy quality factor is significantly compromised by objects passing through the line of sight. Objects having a density lower than animals, such as rain, snow or other weather condition such as high humidity, negatively affect the energy quality factor as well.

In addition, humans passing through the line of sight risk exposure to somewhat high energy levels and possible harm or discomfort. Indeed, specialized sub-terahertz beam systems have been used by the military and other authorities for crowd control and in combat.

Therefore, methods, systems, and apparatus that provide real time detection of moveable objects in the line of sight of a sub-terahertz beam generating system, and selectively downscale a signal transmission level of the source in response to the detected object, would be highly desirable.

### BRIEF DESCRIPTION OF THE DRAWINGS

FIG. 1 is a block diagram of a self-adapting signal communicating system in accordance with an example embodiment illustrating an object moving into and out of a line of sight of a transmitted signal.

FIG. 2 is a signal diagram showing a temporary selective downscaling followed by an up-scaling of a signal transmission level corresponding to the passing of the moving object of through the line of sight of the transmitted signal.

FIG. 3 is a signal diagram showing temporary selective incremental tiered downscaling followed by incremental tiered up-scaling of a signal transmission level corresponding to the presence then absence of plural moving objects or other conditions relative to the medium in the line of sight of the transmitted signal.

FIG. 4 is a more detailed block diagram of the self-adapting signal communicating system of FIG. 1 in accordance with an example embodiment.

FIG. 5 is a flow diagram illustrating a method of self-adapting a signal transmission level in the overall signal communicating system of FIGS. 1 and 4 for control of signal transmission levels responsive to moving objects in the line of sight or for other conditions of the signal transmission medium.

FIG. 6 is a flow diagram illustrating a method of self-adapting a signal transmission level in the first transceiver of FIGS. 1 and 4 for control of signal transmission levels responsive to moving objects in the line of sight or for other conditions of the signal transmission medium.

FIG. 7 is a flow diagram illustrating a method of self-adapting a signal transmission level in the second transceiver of FIGS. 1 and 4 for control of signal transmission levels responsive to moving objects in the line of sight or for other conditions of the signal transmission medium.

FIG. 8 is a schematic diagram of an embodiment of the self-adapting signal communicating system of FIGS. 1 and 4 operative in a personal portable device charging application.

FIG. 9 is a schematic diagram of an embodiment of the self-adapting signal communicating system of FIGS. 1 and 4 operative in a residential video data transmission system application.

FIG. 10 is a schematic diagram of an embodiment of the self-adapting signal communicating system of FIGS. 1 and 4 operative in an automotive energy delivery system application.

### OVERVIEW OF EXAMPLE EMBODIMENTS

In accordance with an example embodiment, a self-adapting signal communication system comprises first and second transceivers wherein a transmission level of a signal transmitted from the first transceiver to the second transceiver is adjusted in accordance with an attenuation of the signal. In the example, the first transceiver includes a first receiver, a first transmitter, a first non-transient memory, and first logic operatively coupled with the first receiver, the first transmitter, and the first non-transient memory. Also in the example, the second transceiver includes a second receiver, a second transmitter, a second non-transient memory, and second logic operatively coupled with the second receiver, the second transmitter, and the second non-transient memory. The first transmitter transmits a first signal to the second transceiver at a first signal transmission level as a first transmitted signal, and the second receiver receives the first transmitted signal as a first received signal. The second logic determines an amount of degradation or attenuation of the first signal in accordance with a degradation processing of data representative of the first signal transmission level and the first received signal, and the second transmitter selectively transmits a downscale command signal to the first receiver in accordance with a level of the amount of degradation or attenuation determined by the second logic. The first receiver receives the downscale command signal. The first logic determines an adjusted signal transmission level in accordance with downscale processing of the downscale command signal, and transmits the first signal at a second signal transmission level different than the first signal transmission level as a second transmitted signal in accordance with the adjusted signal transmission level determined by the first logic.

### DETAILED DESCRIPTION OF EXAMPLE EMBODIMENTS

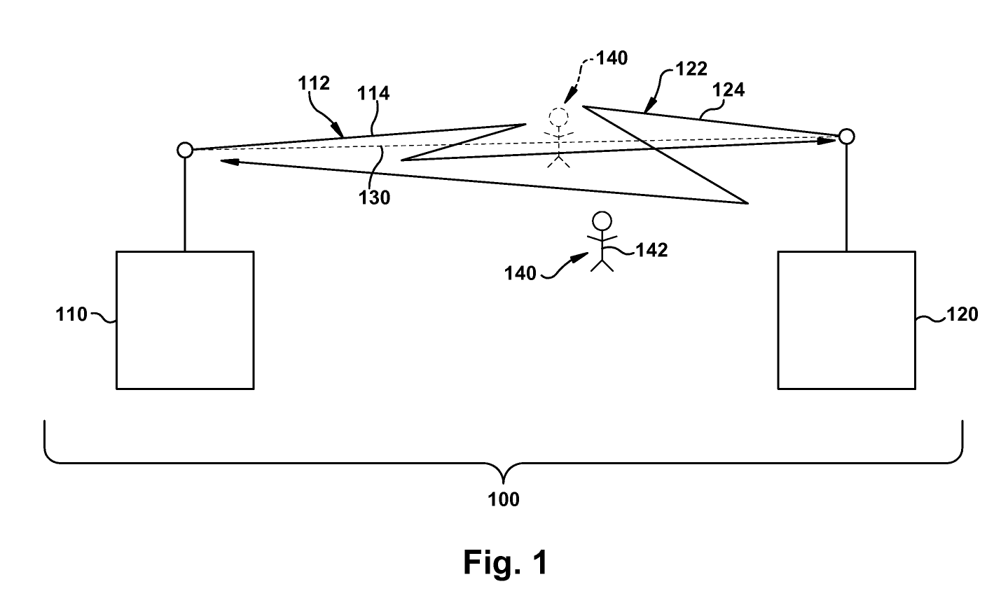

With reference now to the drawing Figures wherein the showings are for purposes of illustrating the example embodiments only, and not for purposes of limiting same, FIG. 1 shows a self-adapting signal communication system 100 in accordance with an example embodiment. The self-adapting signal communication system 100 includes a first transceiver 110 and a second transceiver 120, wherein the first transceiver 110 selectively transmits a first signal 112 to the second transceiver 120, and the second transceiver 120 selectively transmits a second signal 122 to the first transceiver 110. In the example, embodiment the first signal 112 transmitted by the first transceiver 110 is a sub-terahertz directed signal 114 oriented towards the second transceiver 120 along a line of sight 130, and the second signal 122 is an omnidirectional low frequency signal 124 such as for example a WiFi signal. It is to be appreciated that the sub-terahertz directed signal 114 is shown in an exaggerated manner for illustrative purposes only, but that the signal 114 of the embodiment is a directed signal which is highly directionally focused.

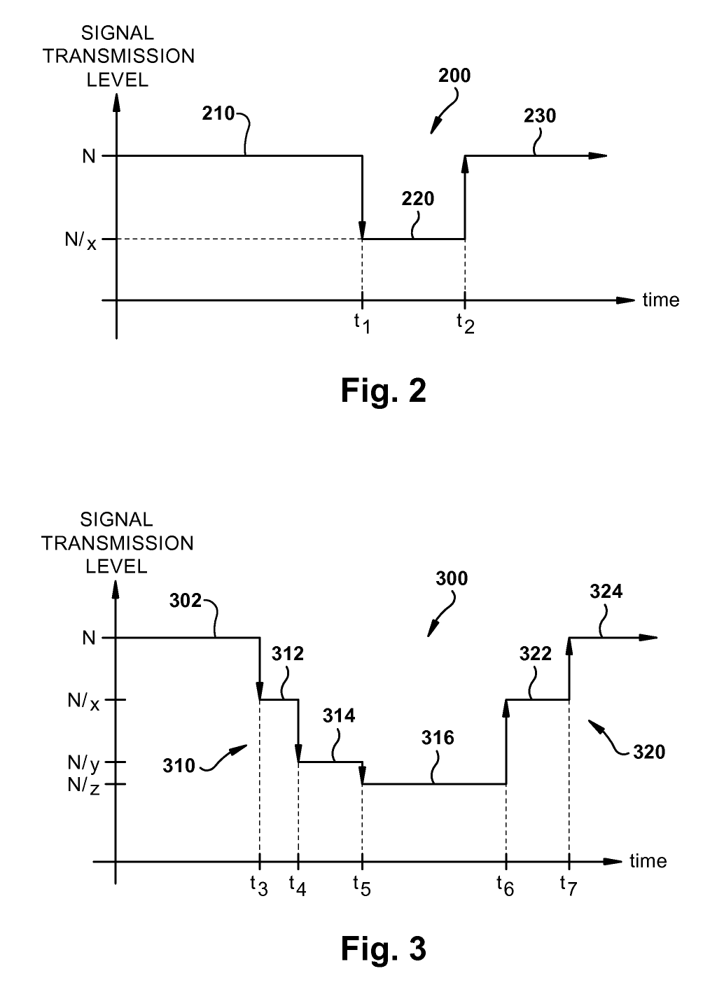

With continued reference to FIG. 1 and with additional reference to FIG. 2 showing a chart of the signal transmission level 200, the directed signal 114 is generated and broadcast from the first transceiver 110 at a first 210 signal transmission level N. However, as shown in FIG. 1 in dot-and-dash, a moving object 140 such as an animal or a human 142 transgresses or otherwise crosses into the line of sight 130 at time t=t₁, whereupon significant attenuation occurs relative to the sub-terahertz directed signal 114.

Since the attenuation of the directed signal 114 is caused in the example by undesirable absorption of the signal energy by the animal or human 142, the system of the example embodiment downscales the signal transmission level of the directed signal 114 from the initial level N to a predetermined reduced transmission level N/x (where x>1). The second transceiver 120 determines an amount of degradation of the first signal 112 in accordance with a degradation processing of data representative of the first signal transmission level N and a level of signal as received by the second transceiver 120, and sends data representative of the determined degradation of the signal as downscale command data in the second signal 122. In the example embodiment, the first transceiver 110 is responsive to downscale command data contained in the low frequency signal 124 generated by downscale processing logic in the second transceiver 120 to reduce at time t=t₁ the signal transmission level from the first level N to the second 220 signal transmission level N/x.

The animal or human 142 remains in the line of sight 130 during the time period t₁>t>t₂ and, accordingly, the first transceiver continues to generate and broadcast the directed signal 114 at the reduced or second 220 signal transmission level N/x during that time period as shown.

With continued reference to FIGS. 1 and 2, the moving object 140 such as the animal or human 142 moves out of the line of sight 130 at time t=t₂ whereupon degradation processing logic of the second transceiver 120 is operable to detect the reduction in attenuation of the first signal 112 and generate an upscale command signal for transmission to the first transceiver via the second signal 122. Accordingly, at time t₂<t, the first transceiver resumes transmitting the first signal 112 at an increased signal 230 level and preferably at the first 210 signal transmission level N.

It is to be appreciated that although the moving object 140 of the example was an animal or human 142, the embodiments of the system herein react similarly for any object or objects passing through or into the line of sight 130. Still further, it is to be appreciated that the embodiments herein react similarly for any cause of attenuation of the first directed signal 112 such as may include weather conditions including humidity, rain, snow, or the like.

FIG. 3 illustrates an example resultant signal transmission level 300 in accordance with a further example embodiment of operation of the system 100 shown in FIG. 1, wherein incremental downscaling 310 and incremental up-scaling 320 of the directed signal 114 is implemented. In the example, the incremental downscaling 310 comprises three (3) tiers of signal levels from a reduction of an initial level 302, including a first tier signal level 312 wherein the signal transmission level is reduced to N/x at t=t₃, a second tier signal level 314 wherein the signal transmission level is reduced to N/y at t=t₄, and a third tier signal level 316 wherein the signal transmission level is reduced to N/z at t=t₅. Further in this example embodiment, the incremental up-scaling 320 comprises two (2) tiers of signal levels, including a first tier signal level 322 wherein the signal transmission level is incremented to N/x at t=t₆, and a second tier signal level 324 wherein the signal transmission level is returned to N at t=t₇.

In the example shown in FIG. 3, for example, a single person 142 enters near to the line of sight 130 at time t=t₃ causing some amount of attenuation of the sub-terahertz directed signal 114 wherein the system 100 senses the attenuation and reacts by reducing the signal level 300 from the original 302 level N to a reduced 312 level N/x. Thereafter, a second person joins the first person near the line of sight 130 at time t=t₄ causing some amount of additional attenuation of the directed signal 114 wherein the systems 100 senses the attenuation and reacts by further reducing the signal level 300 from the reduced 312 level N/x to a further reduced 314 level N/y. Thereafter, a third person or a small animal joins the first two people near the line of sight 130 at time t=t₅ causing some amount of further additional attenuation of the directed signal 114 wherein the system senses the attenuation and reacts by further reducing the signal level 300 from the further reduced 314 level N/y to a still further reduced 316 level N/z.

It is to be appreciated that the embodiments are not limited to any fixed number of incremental downscaling and/or up-scaling tiers and that the three (3) downscaling tiers 312, 314, 316 and two (2) up-scaling tiers 322, 324 are illustrated by way of example only. Further, it is to be appreciated that downscaling may be extended to include downscaling the signal transmission level to a level of zero (0) wherein the directed signal 114 may be discontinued or otherwise halted or suspended temporarily in accordance with the moving objects, weather conditions or other signal debilitating conditions. Lastly with reference to FIG. 3, it is to be appreciated that embodiments are not limited to asymmetrical incremental downscaling and up-scaling tiers as shown, but rather may include an equal number of downscaling and up-scaling tiers. The equal number of downscaling and up-scaling tiers may be controlled to be asymmetric, however, relative to signal transmission levels during downscaling versus up-scaling.

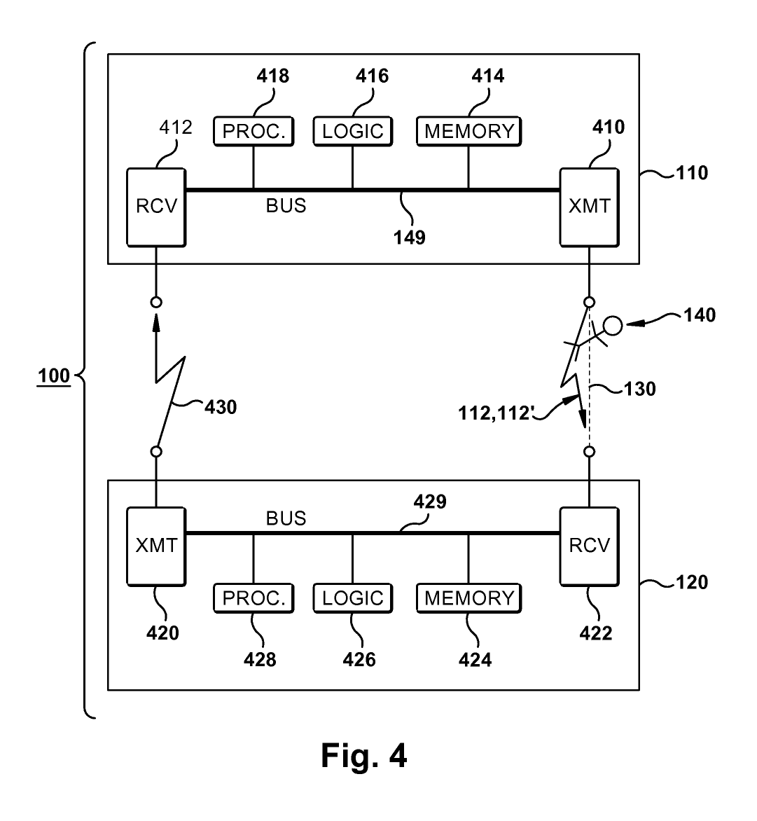

FIG. 4 is a more detailed block diagram of the self-adapting signal communicating system 100 shown in FIG. 1 in accordance with an example embodiment. With reference now to that Figure, the first transceiver 110 includes a first transmitter 410, a first receiver 412, a first non-transient memory 414, first logic 416, and a first processor 418 operatively coupled with the first receiver 412, the first transmitter 410, the first non-transient memory 414 and the first logic 416 such as by a suitable first communication and control bus 419 or the like. Similarly, the second transceiver 120 includes a second transmitter 420, a second receiver 422, a second non-transient memory 424, second logic 426, and a second processor 428 operatively coupled with the second receiver 422, the second transmitter 420, the second non-transient memory 424 and the second logic 426 such as by a suitable second communication and control bus 429 or the like.

The first and second logic 416, 426 and/or memories 414, 424 store instructions executable by the respective first and second processors 418, 428 and, when executed, cause the first and second transceivers 110, 120 of the system 100 of the example embodiment to operate to perform real time detection of moveable objects in, about or near a line of sight 130 of sub-terahertz electromagnetic waves communicate between the first and second transceivers 110, 120 of the system 100, and to perform downscaling and/or up-scaling the signal levels responsive to the presence and/or absence respectively of the moveable object 140 in the line of sight 130.

In accordance with the example embodiment, the first transmitter 410 transmits the first signal 112 to the second transceiver 120 at a first signal transmission level N as a first transmitted signal. The second receiver 422 of the second receiver 120 receives the first transmitted signal 112 as a first received signal, and the second logic 426 executes to determine an amount of degradation of the first signal 112 in accordance with a degradation processing of data representative of the first signal transmission level and the first received signal 112. The data representative of the first signal transmission level may be communicated to the second transceiver 120 within the first received signal 112, or part of a separate signal (not shown) or via an associated communication network (not shown), such as, for example a local area network (LAN) or a wireless local area network (WLAN). The second transmitter 420 selectively transmits a downscale command signal 122 to the first receiver 412 in accordance with a level of the amount of degradation determined by the second logic 426. The first receiver 412 receives the downscale command signal 122 and the first logic 416 executes to determine an adjusted signal transmission level in accordance with downscale processing of the downscale command signal 122. Lastly, the first transmitter 410 transmits the first signal 112 at a second signal transmission level N/x different than the first signal transmission level N as a second transmitted signal 112′ in accordance with the adjusted signal transmission level determined by the first logic 416.

In accordance with a particular example embodiment, the first transmitter 410 transmits the first signal 112 as the first transmitted signal at the first signal transmission level N comprising a first signal transmission frequency F1 and a first signal transmission energy E1. The first transmitter 410 is configured to transmit the first signal 112 at the second signal transmission level N/x as the second transmission signal 112′ comprising one or more of a second transmission frequency F2 less than the first signal transmission frequency F1 or a second signal transmission energy E2 less than the first signal transmission energy E1. In accordance with the embodiment, the first transmitter 410 selectively transmits the first signal 112 at the first signal transmission level E1 comprising a first signal transmission frequency F1 of about 194.2 GHz, and the first transmitter 410 selectively transmits the second signal 112′ at the second signal transmission level N/x comprising a second signal transmission frequency F2 of about 6 GHz. Further in accordance with the embodiment, the first transmitter 410 selectively transmits the first signal 112 at the first signal transmission level E1 comprising a first signal transmission energy of about 100 Watts, and the first transmitter 410 selectively transmits the second signal 112′ at the second signal transmission level E2 comprising a second signal transmission energy of about 15 Watts.

As noted above, the system 100 of the example embodiment is operable to upscale the first signal transmission level when the attenuation of the signal is improved such as for example when the moving object 140 exits the line of sight 130. In this regard, the second receiver 422 receives the second transmitted signal as a second received signal, and the second logic 426 determines an updated amount of degradation of the second signal 122′ in accordance with the degradation processing of data representative of the second signal transmission level and the second received signal. The second transmitter 420 selectively transmits an upscale command signal 430 to the first receiver 412 in accordance with a level of an updated amount of degradation determined by the second logic 426. The first receiver 412 receives the upscale command signal 430, and the first logic 416 determines an updated signal transmission level N in accordance with the upscale processing of the upscale command signal 430. Thereafter, the first transmitter 410 transmits the second signal 122′ at a third signal transmission level N greater than the second signal transmission level N/x as a third transmitted signal 122″ in accordance with the updated signal transmission level determined by the first logic 416.

In a further example embodiment, the second logic 426 includes machine learning logic configured to determine the amount of degradation of the first signal 122 in accordance with machine learning degradation processing of the first transmitted signal 122 and the first received signal. More particularly, in an example embodiment, the machine learning logic is configured to determine the amount of degradation of the first signal in accordance with the machine learning degradation processing of a plurality of first transmitted signals and a plurality of first received signals over a predetermined time period.

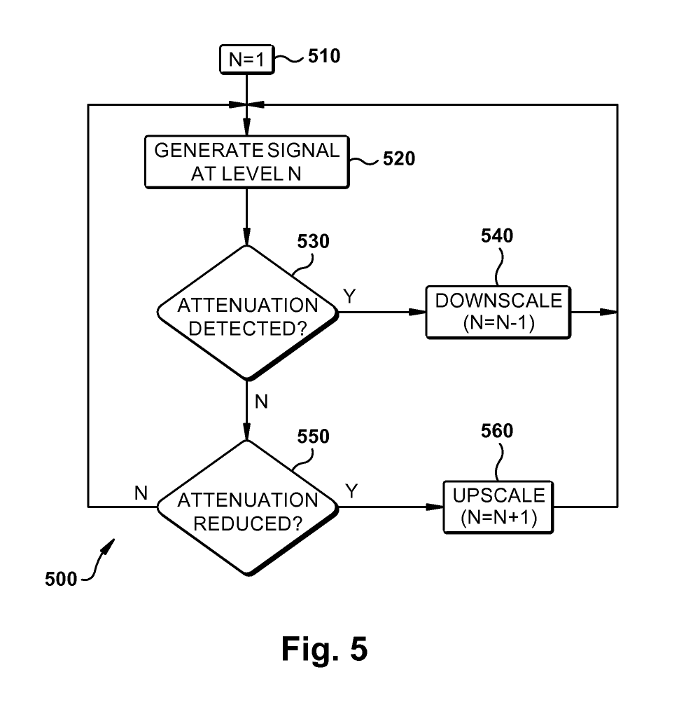

FIG. 5 presents a simplified flow diagram of a method 500 used by the overall system 100 described above for controlling signal transmission levels in accordance with moving objects entering into the line of sight or other factors influencing changing characteristics of the medium in the line of sight. A nominal initial signal transmission level (n=1) is selected at step 510. Once selected, the transmitter 410 is configured to generate and transmit at 520 the signal 112 at the nominal signal transmission level such as, for example, at a sub-terahertz frequency and at a first signal strength.

At 530, the logic 426 of the second transceiver 120 is operative to determine whether a moving object 140 has passed into the line of sight 130 or, equivalently, whether any other physical or other properties of the medium of the line of sight 130 have changed having an adverse effect on the signal 112. If the conditions of the medium comprising the line of sight 130 have not changed as determined at 530, the first transceiver 110 continues to transmit the first signal 112 at the first signal transmission level N.

However, if at 530 it is determined that the characteristics of the medium comprising the line of sight 130 have changed, the first and second transceivers 110, 120 operate at 530 to execute a downscaling of the signal transmission level from the original signal transmission level N to a reduced or decremented signal transmission level and equals N−1.

At step 550, the logic 426 of the second transceiver 120 determines whether the attenuation of the first transmitted signal has been reduced. If the attenuation of the signal is not reduced, the first transceiver 110 continues to transmit the first signal at the original signal transmission level N at step 520. However, if an attenuation of the signal is determined by the logic 426 of the second transceiver 120, the first and second transceivers 110, 120 cooperate to perform an upscale such as shown at 320 of FIG. 3 wherein the signal transmission level is increased from an original level N to an increased energy level N equals N+1 at step 560.

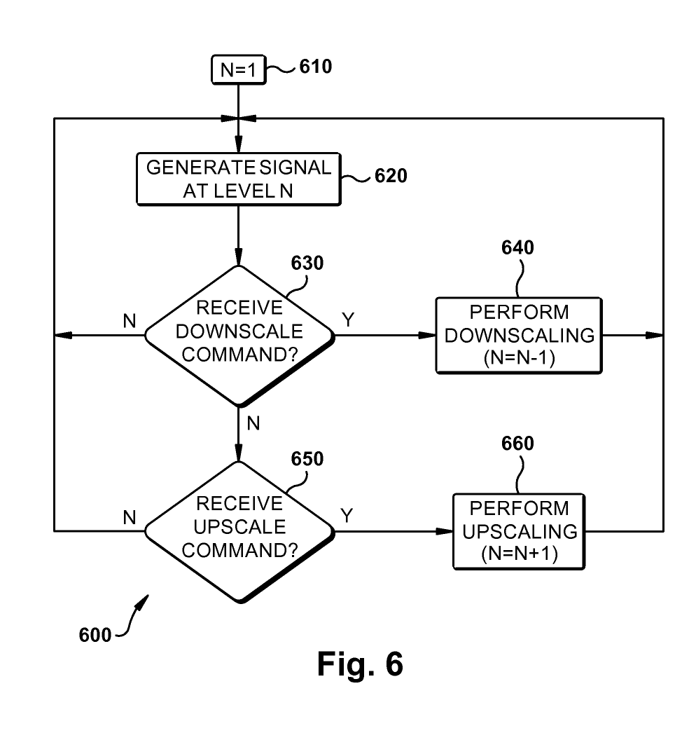

FIG. 6 presents a simplified flow diagram of a method 600 used by the first transceiver 110 in performing the first transceiver portion of the method 500 illustrated in FIG. 5. Initially, the transceiver 110 generates the first signal 112 at the first transmission level N.

At step 630, the receiver 412 of the first transceiver 110 selectively receives a downscale command from the transmitter 420 of the second transceiver 120. If it is determined at step 630 that no downscale command has been received, the first transceiver 110 continues to generate the first signal 112 at the first transmission level N. However, if it is determined at step 630 that a downscale command has been received by the first transceiver from the second transceiver 120, the logic 416 of the first transceiver 110 performs a downscaling operation at 630 wherein the signal transmission level is reduced from an original level N to a downscaled or reduced level N=N−1.

At step 650, the logic 416 of the first transceiver 110 determines whether an upscale command has been received from the second transceiver 120. If an upscale command has not been received at step 540, the first transceiver 110 continues to generate and transmit the first signal 112 at the first transmission level N. However, if it is determined at step 640 that an upscale command has been received from the second transceiver 120, the logic 416 of the first transceiver 110 performs an upscale operation at step 660 wherein the original signal transmission level N is increased or otherwise up-scaled to a signal transmission level N=N+1.

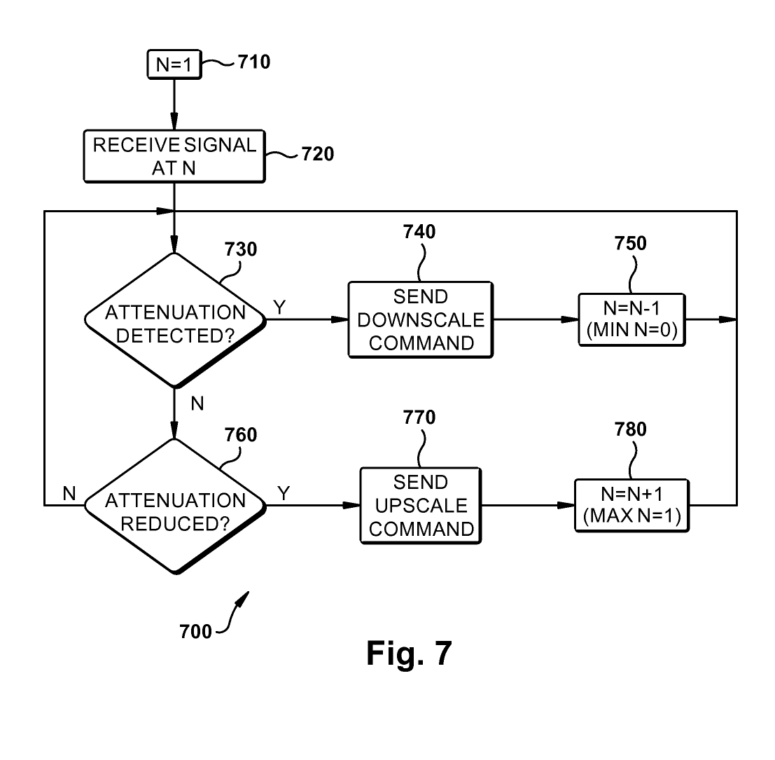

FIG. 7 presents a simplified flow diagram of a method 700 used by the second transceiver 120 in performing the second transceiver portion of the method 500 illustrated in FIG. 5. At step 710, the value of the signal transmission level N is initialized as N=1. Next, at step 720, the second receiver 422 of the second transceiver 120 receives the first signal sent from the transmitter 410 of the first transceiver 110. At step 730, the logic of the 426 of the second transceiver determines whether an attenuation of the first signal 112 sent along the line of sight 130 is detected. If an attenuation is determined by the logic 426, a downscale command is prepared and sent at step 740 from the transmitter 420 of the second transceiver 120 to the receiver 412 of the first transceiver 110. Thereafter, at step 750, the logic 426 adjusts the internal signal transmission level setting from end to a downscaled or reduced value N=N−1.

If no attenuation is detected by the logic 426 at step 730, the logic 426 determines at step 760 whether any attenuation of the signal 112 is reduced. If no reduction in the signal transmission level is determined at step 760, the logic 426 continues to check for any further signal attenuation at step 730. However, if a reduction in the signal transmission level is determined at step 760, the second transceiver 120 prepares and sends at step 770 an upscale command signal from the second transceiver 420 to the first receiver 412. Thereafter, the logic 426 updates the signal transmission level counter from the original signal transmission level N to a revised or upscaled level N=N+1.

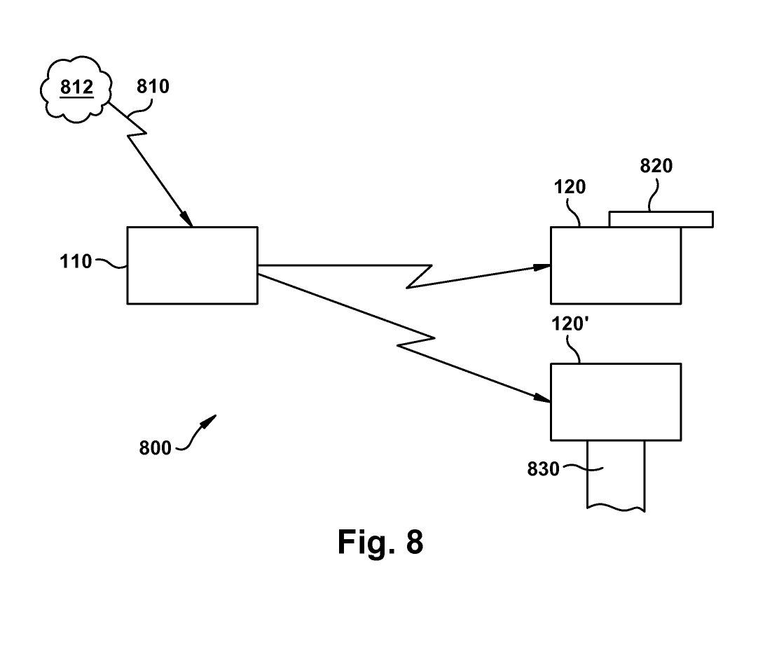

FIG. 8 is a schematic diagram of an embodiment of the self-adapting signal communication system 100 of FIGS. 1 and 4 operative in a personal portable device charging application 800. As shown there, the personal portable device charging application 800 includes a first transceiver 110 configured to receive signals 810 from an associated source 812, and a pair of second transceivers 120, 120′ respectively associated with a device charging pad 820 and a wearable cloak device 830. The transceivers 120, 120′ are each configured to receive a directed charging signal from the first transceiver 110 and to convert the signal into a predetermined voltage or current for charging portable electronic devices. The charging pad 820 is configured to charge the associated portable cellular device by communicating energy from the signal derived from the first transceiver 110 using near-field charging techniques. Similarly, the wearable cloak is configured to receive the charging signal and to convert the energy therefrom into a voltage or current suitable for use with portable devices associated with the wearable cloak 830.

In the embodiment shown in FIG. 8, each of the second transceivers 120, 120′ is operable in a manner described above with respect to the second transceiver 120 (FIGS. 1 and 4) for sensing or otherwise determining attenuation and generating downscale signals for the first transceiver 110. Similarly, the first transceiver 110 is operable in a manner described above with respect to the first transceiver 110 (FIGS. 1 and 4) for receiving the downscale and upscale signals from the second transceivers 120, 120′ and downscaling or upscaling respectively, the signal transmitted to the transceivers 120, 120′.

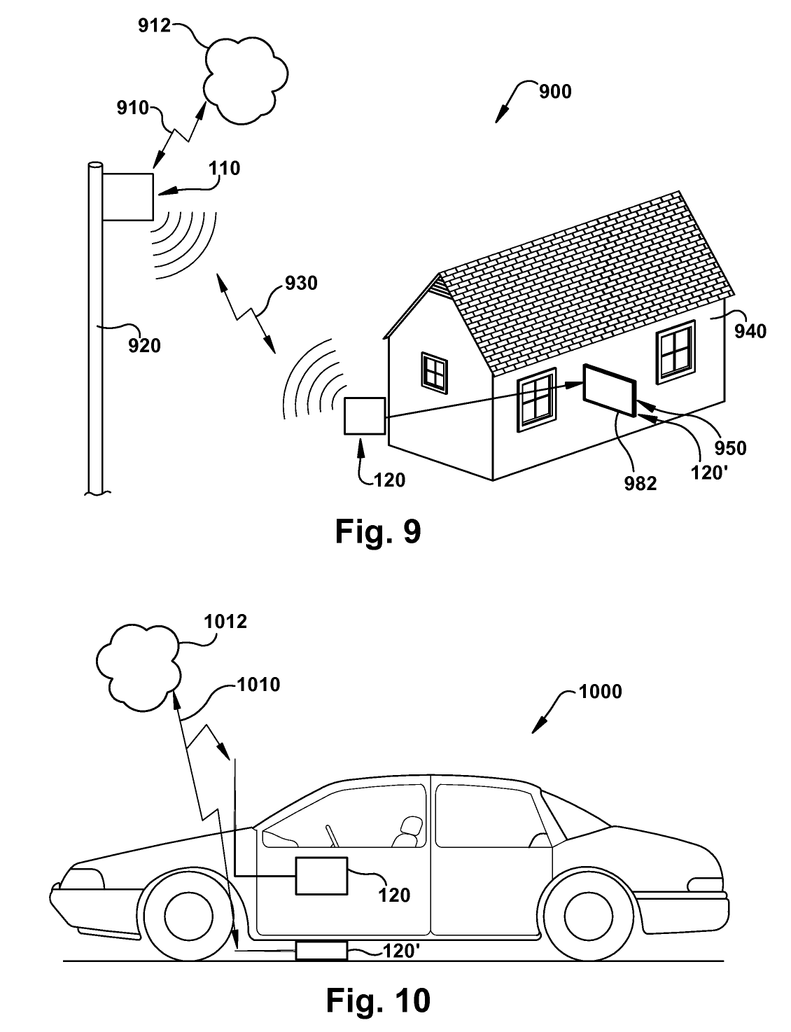

FIG. 9 is a schematic diagram of the embodiment of the self-adapting signal communicating system 100 of FIGS. 1 and 4 operative in a residential video data transmission system 900 wherein a first transceiver 110 is configured to receive a video feed signal 910 from an associated source such as, for example, a remote satellite 912. The first transceiver 110 is suitably positioned on an outdoor utility pole 920 and is configured to send a directed video feed signal 930 to a transceiver 120 disposed in a selected position on an associated residential building 940 wherein the second transceiver 120′ is configured to receive the signal 930 and convert the signal to a video feed signal for reception by an associated video display device 950 such as, for example, a television 952.

In the embodiment shown in FIG. 9, each of the second transceivers 120, 120′ is operable in a manner directed above with respect to the second transceiver 120 (FIGS. 1 and 4) for sensing or otherwise determining attenuation and generating downscale signals for the first transceiver 110. Similarly, the first transceiver 110 is operable in a manner described above with respect to the first transceiver 110 (FIGS. 1 and 4) for receiving the downscale and upscale signals from the second transceiver 120, 120′ and downscaling or upscaling, respectively, the signal transmitted to the transceivers 120, 120′.

FIG. 10 is a schematic diagram of an embodiment of the self-adapting signal communicating system 100 of FIGS. 1 and 4 operative in an auto energy delivery system 1000. The system includes a first transceiver 120 configured to receive a charging signal 1010 from an associated source 1012 such as, for example, a satellite, or other utility delivery system, and a second transceiver 120′ located beneath the automobile. The system 1000 is configured to detect moveable objects in a line of sight of a sub-terahertz electromagnetic wave delivered to the charging system 1000 and to downscale and/or upscale the signal levels responsive to the presence and/or absence, respectively of the moveable object in the line of sight. The location of the second transceiver 120′ beneath the automobile is useful in other applications such as roadways and parking lots wherein similar transceivers could be used to charge parked vehicles or vehicles paused at traffic light system stops or the like.

The embodiments herein have been described with reference to preferred structures and method steps. However, it is to be appreciated that the claims herein are not limited to those precise structures, steps, or their specific descriptions. Rather, the claims are to be given their broadest possible interpretation as appropriate.

In addition, while certain embodiments have been described, these embodiments have been presented by way of example only, and are not intended to limit the scope of the claimed inventions. Indeed, the novel embodiments described herein may be embodied in a variety of other forms; furthermore, various omissions, substitutions and changes in the form of the embodiments described herein may be made without departing from the spirit of the claimed inventions. The accompanying claims and their equivalents are intended to cover such forms or modifications as would fall within the scope and spirit of the inventions.

1. A self-adapting signal communication system comprising:
a first transceiver comprising a first receiver, a first transmitter, a first non-transient memory, and first logic operatively coupled with the first receiver, the first transmitter, and the first non-transient memory;
a second transceiver comprising a second receiver, a second transmitter, a second non-transient memory, and second logic operatively coupled with the second receiver, the second transmitter, and the second non-transient memory;
wherein the first transmitter transmits a first signal to the second transceiver at a first signal transmission level as a first transmitted signal;
wherein the second receiver receives the first transmitted signal as a first received signal;
wherein the second logic determines an amount of degradation of the first signal in accordance with a degradation processing of data representative of the first signal transmission level and the first received signal;
wherein the second transmitter selectively transmits a downscale command signal to the first receiver in accordance with a level of the amount of degradation determined by the second logic;
wherein the first receiver receives the downscale command signal;
wherein the first logic determines an adjusted signal transmission level in accordance with downscale processing of the downscale command signal; and
wherein the first transmitter transmits the first signal at a second signal transmission level different than the first signal transmission level as a second transmitted signal in accordance with the adjusted signal transmission level determined by the first logic.

2. The self-adjusting signal communicating system according to claim 1 wherein:
the first transmitter transmits the first signal as the first transmitted signal at the first signal transmission level comprising a first signal transmission frequency and a first signal transmission energy; and
the first transmitter transmits the first signal at the second signal transmission level as the second transmission signal comprising one or more of a second transmission frequency less than the first signal transmission frequency or a second signal transmission energy less than the first signal transmission energy.

3. The self-adapting signal communicating system according to claim 2, wherein:
the first transmitter selectively transmits the first signal at the first signal transmission level comprising a first signal transmission frequency of about 194.2 GHz; and
the first transmitter selectively transmits the second signal at the second signal transmission level comprising a second signal transmission frequency of about 6 GHz.

4. The self-adapting signal communicating system according to claim 2, wherein:
the first transmitter selectively transmits the first signal at the first signal transmission level comprising a first signal transmission energy of about 100 Watts; and
the first transmitter selectively transmits the second signal at the second signal transmission level comprising a second signal transmission energy of about 15 Watts.

5. The self-adapting signal communicating system according to claim 1:
wherein the second receiver receives the second transmitted signal as a second received signal;
wherein the second logic determines an updated amount of degradation of the second signal in accordance with the degradation processing of data representative of the second signal transmission level and the second received signal;
wherein the second transmitter selectively transmits an upscale command signal to the first receiver in accordance with a level of an updated amount of degradation determined by the second logic;
wherein the first receiver receives the upscale command signal;
wherein the first logic determines an updated signal transmission level in accordance with the upscale processing of the upscale command signal; and
wherein the first transmitter transmits the second signal at a third signal transmission level greater than the second signal transmission level as a third transmitted signal in accordance with the updated signal transmission level determined by the first logic.

6. The self-adapting signal communicating system according to claim 1, wherein:
the second logic comprises machine learning logic configured to determine the amount of degradation of the first signal in accordance with machine learning degradation processing of the first transmitted signal and the first received signal.

7. The self-adapting signal communicating system according to claim 6, wherein:
the machine learning logic is configured to determine the amount of degradation of the first signal in accordance with the machine learning degradation processing of a plurality of first transmitted signals and a plurality of first received signals over a predetermined time period.

8. A method for use in a self-adapting signal communication system including first and second transceivers, the first transceiver comprising a first receiver, a first transmitter, a first non-transient memory, and first logic, and the second transceiver comprising a second receiver, a second transmitter, a second non-transient memory, and second logic, the method comprising:
transmitting by the first transmitter a first signal to the second transceiver at a first signal transmission level as a first transmitted signal;
receiving the first transmitted signal by the second receiver as a first received signal;
determining by the second logic an amount of degradation of the first signal in accordance with a degradation processing of data representative of the first signal transmission level and the first received signal;
selectively transmitting by the second transmitter a downscale command signal to the first receiver in accordance with a level of the amount of degradation determined by the second logic;
receiving the downscale command signal by the first receiver;
determining by the first logic an adjusted signal transmission level in accordance with downscale processing of the downscale command signal; and
transmitting the first signal by the first transmitter at a second signal transmission level different than the first signal transmission level as a second transmitted signal in accordance with the adjusted signal transmission level determined by the first logic.

9. The method according to claim 8 wherein:
the transmitting the first signal by the first transmitter as the first transmitted signal at the first signal transmission level comprises transmitting the first signal by the first transmitter at a first signal transmission frequency and at a first signal transmission energy; and
the transmitting the first signal by the first transmitter as the second transmitted signal at the second signal transmission level comprises transmitting the first signal by the first transmitter at one or more of a second transmission frequency less than the first signal transmission frequency or a second signal transmission energy less than the first signal transmission energy.

10. The method according to claim 9, wherein:
the transmitting the first signal at the first signal transmission level by the first transmitter comprises selectively transmitting the first signal at a first signal transmission frequency of about 194.2 GHz; and
the transmitting the second signal at the second signal transmission level by the first transmitter comprises selectively transmitting the second signal at a second signal transmission frequency of about 6 GHz.

11. The method according to claim 9, wherein:
the transmitting the first signal at the first signal transmission level by the first transmitter comprises selectively transmitting the first signal at a first signal transmission energy of about 100 Watts; and
the transmitting the second signal at the second signal transmission level by the first transmitter comprises selectively transmitting the second signal at a second signal transmission energy of about 15 Watts.

12. The method according to claim 8, further comprising:
receiving the second transmitted signal by the second receiver as a second received signal;
determining by the second logic an updated amount of degradation of the second signal in accordance with the degradation processing of data representative of the second signal transmission level and the second received signal;
selectively transmitting by the second transmitter an upscale command signal to the first receiver in accordance with a level of an updated amount of degradation determined by the second logic;
receiving by the first receiver the upscale command signal;
determining by the first logic an updated signal transmission level in accordance with the upscale processing of the upscale command signal; and
transmitting by the first transmitter the second signal at a third signal transmission level greater than the second signal transmission level as a third transmitted signal in accordance with the updated signal transmission level determined by the first logic.

13. The method according to claim 8, further comprising:
determining by machine learning logic of the second logic the amount of degradation of the first signal in accordance with machine learning degradation processing of the first transmitted signal and the first received signal.

14. The method according to claim 13, wherein:
the determining by the machine learning logic comprises determining the amount of degradation of the first signal in accordance with the machine learning degradation processing of a plurality of first transmitted signals and a plurality of first received signals over a predetermined time period.

15. A first transceiver for use in an associated self-adapting signal communication system including a second transceiver comprising a second receiver, a second transmitter, a second non-transient memory, and second logic operatively coupled with the second receiver, the second transmitter, and the second non-transient memory, the first transceiver comprising:
a first receiver;
a first transmitter;
a first non-transient memory; and
first logic operatively coupled with the first receiver, the first transmitter, and the first non-transient memory;
wherein the first transmitter transmits a first signal to the second transceiver at a first signal transmission level as a first transmitted signal;
wherein the first receiver receives a downscale command signal from the associated second transceiver;
wherein the first logic determines an adjusted signal transmission level in accordance with downscale processing of the downscale command signal; and
wherein the first transmitter transmits the first signal at a second signal transmission level different than the first signal transmission level as a second transmitted signal in accordance with the adjusted signal transmission level determined by the first logic.

16. The first transceiver according to claim 15, wherein:
the first transmitter transmits the first signal as the first transmitted signal at the first signal transmission level comprising a first signal transmission frequency and a first signal transmission energy; and
the first transmitter transmits the first signal at the second signal transmission level as the second transmission signal comprising one or more of a second transmission frequency less than the first signal transmission frequency or a second signal transmission energy less than the first signal transmission energy.

17. The first transceiver according to claim 16, wherein:
the first transmitter selectively transmits the first signal at the first signal transmission level comprising a first signal transmission frequency of about 194.2 GHz; and
the first transmitter selectively transmits the second signal at the second signal transmission level comprising a second signal transmission frequency of about 6 GHz.

18. The first transceiver according to claim 16, wherein:
the first transmitter selectively transmits the first signal at the first signal transmission level comprising a first signal transmission energy of about 100 Watts; and
the first transmitter selectively transmits the second signal at the second signal transmission level comprising a second signal transmission energy of about 15 Watts.

19. The first transceiver according to claim 15:
wherein the first receiver receives an upscale command signal from the second transceiver;
wherein the first logic determines an updated signal transmission level in accordance with the upscale processing of the upscale command signal; and
wherein the first transmitter transmits the second signal at a third signal transmission level greater than the second signal transmission level as a third transmitted signal in accordance with the updated signal transmission level determined by the first logic.
